(19) United States
(12) Patent Application Publication
(10) Pub. No.: US 2013/0212688 A1
(43) Pub. Date: Aug. 15, 2013

(54) SYSTEM FOR SHARING A USERS PERSONAL DATA

(71) Applicant: Dale Jankowski, Taylorsville, UT (US)

(72) Inventor: Dale Jankowski, Taylorsville, UT (US)

(21) Appl. No.: 13/372,352

(22) Filed: Feb. 13, 2012

(51) Int. Cl. G06F 21/00

(52) U.S. Cl. 726/26

(57) ABSTRACT

One example embodiment includes a method for sharing a user's personal data. The method includes obtaining identifying information. The method also includes confirming a user's identify. The method further includes releasing the user's personal data.

### CROSS-REFERENCE TO RELATED APPLICATIONS

Not applicable.

### BACKGROUND OF THE INVENTION

The digitalization of data has led to great achievements for mankind. It allows us to make financial transactions with greater ease, obtain data almost at will, communicate more efficiently, share necessary information and participate in many other interactions. For example, digital medical records can allow physicians to better treat patients and avoid duplicative efforts. However, there are many problems that arise to the digitalization of data.

For example, identity theft is an increasing problem. In particular, a thief obtains personal information and uses that information to defraud the person. For example, the identity thief may obtain a person's credit card number and use that number to purchase items, with the person to whom the credit card is issued forced to pay the bills.

Prevention of identity theft has come to consume many resources and man hours. Many financial institutions have whole departments devoted to dealing with the effects of identity theft and other departments which are devoted to preventing identity theft. This consumes resources that could otherwise be devoted to other activities. Additionally, consumers are left to deal with the consequences of identity theft, which may last months or years.

Accordingly, there is a need in the art for a system which helps protect digital data. Further, there is a need in the art for the system to make the data available when necessary. In addition, there is a need in the art for the system to be flexible enough to allow the user to determine whether to share the data.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for sharing a user's personal data. The method includes obtaining identifying information. The method also includes confirming a user's identify. The method further includes releasing the user's personal data.

Another example embodiment includes a system for sharing a user's personal data. The system includes a logic device. The system also includes an identification apparatus, where the identification apparatus is configured to confirm a user's identify. The system further includes a transceiver, where the transceiver is configured to connect the system to a network.

Another example embodiment includes a system for sharing a user's personal data. They system includes a logic device. The system also includes an identification apparatus, where the identification apparatus is configured to confirm a user's identify. The system further includes a display, where the display is configured to display the user's personal data.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for personal data storage and retrieval;

FIG. 2 is a block diagram illustrating an example of a personal device;

FIG. 3 illustrates an example of a personal device; and

FIG. 4 is a flowchart illustrating a method of sharing personal data.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

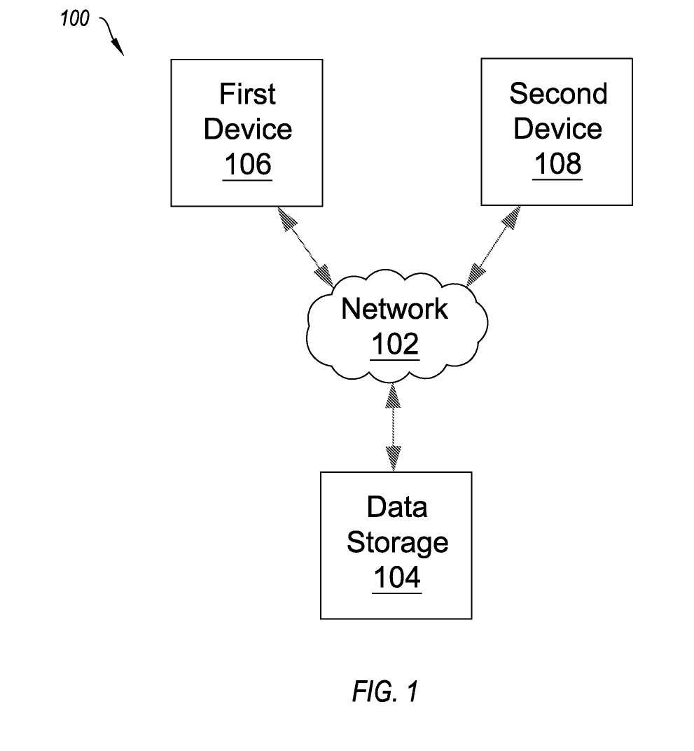

FIG. 1 illustrates an example of a system 100 for personal data storage and retrieval. In at least one implementation, the system 100 can be used to store financial, health or other data. The system 100 can make the data available to the person with whom it is associated and/or to others who are authorized by the person with whom the data is associated. For example, the system 100 can make health data available to a user's physician or can make financial data available to a user's financial planner.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include data storage 104. In at least one implementation, the data storage 104 can include any system capable of storing and retrieving the desired data files. For example, the data storage 104 can include an electronic database capable of electronically storing data. E.g., the database 110 can include memory or memory banks. Additionally or alternatively, the data storage 104 can include processors or other logic devices capable of executing software or carrying out other computer algorithms. The data storage 104 can allow a user to access the hardware of the data storage 104 for remote computing or for information retrieval.

FIG. 1 further shows that the system 100 can include a first device 106. In at least one implementation, the first device 106 can be used to confirm a user's identity. For example, the first device 106 can confirm the user's identity through biometric identification. Additionally or alternatively, the first device 106 can confirm the user's identify through any other desired means. For example, the first device 106 can include a magnetic strip with data confirming access. Additionally or alternatively, the first device 106 can require the user to enter information, such as password or pin, which confirms the user's identity.

FIG. 1 additionally shows that the system 100 can include a second device 108. In at least one implementation, the second device 108 can receive the data. I.e., once the user's identity is confirmed, the requested data can be transferred to the second device 108. The second device 108 can include a computer, mobile device or any other device capable of receiving the data. The second device 108 can receive the data directly from the data storage 104 over the network 102. Additionally or alternatively, the second device 108 can receive the data from the first device 106. I.e., the first device 106 can retrieve the data, which it then transmits directly to the second device 108.

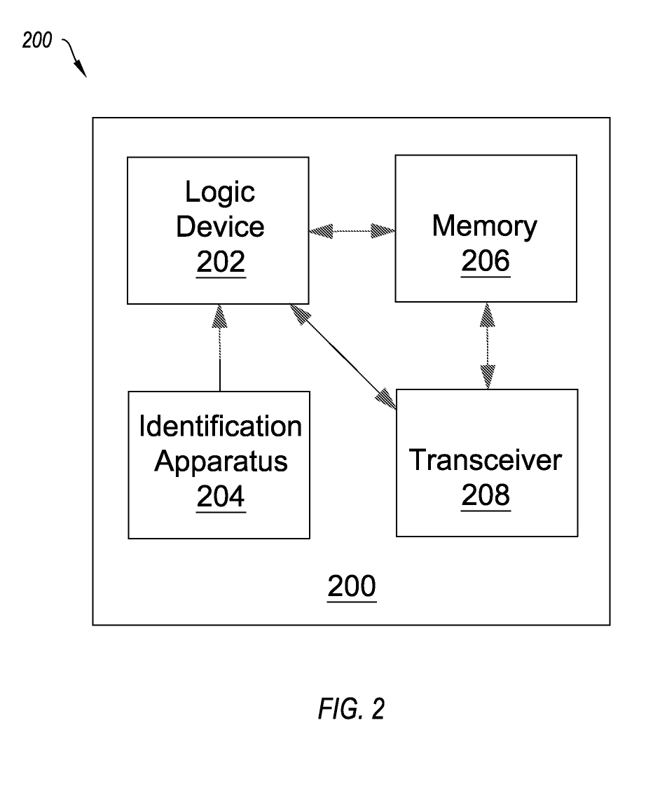

FIG. 2 is a block diagram illustrating an example of a personal device 200. In at least one implementation, the personal device 200 can include the first device 106 of FIG. 1. The personal device 200 can be used to confirm personal information. For example, the personal device 200 can confirm a user's identity and then provide the desired personal data. The data may be stored on the personal device 200 or can be downloaded to the personal device 200, as desired. Additionally or alternatively, the personal device 200 can be used to identify the position of the user. For example, the personal device 200 can be used by parents to locate their children.

FIG. 2 shows that the personal device 200 can include a logic device 202. In at least one implementation, a logic device 202 can include any device capable of performing logic functions. For example, the logic device 202 can perform Boolean logic or can produce a pre-determined output based on input. The logic device 202 can include ROM memory, programmable logic device (PLD), programmable array logic (PAL), generic array logic (GAL), complex programmable logic device (CPLD), field programmable gate arrays (FPGA), logic gates, processors or any other device capable of performing logic functions.

In at least one implementation, the logic device 202 can control the functions of the other components of the personal device 200. In particular, the logic device 202 can ensure that the components of the personal device 200 perform their desired function at the appropriate time and in the appropriate manner. The timing of functions can be critical to ensure that the data is protected until the user desires to share the data.

FIG. 2 also shows that the personal device 200 can include an identification apparatus 204. In at least one implementation, the identification apparatus 204 can interact with the user in order to confirm the user's identity. For example, the identification apparatus 204 can confirm the user's identity through biometric identification. Biometric identification, or biometrics, comprises methods for uniquely recognizing individuals based upon one or more intrinsic physical or behavioral traits. Biometric characteristics can be divided in two main classes. Physiological biometrics are related to the shape of the body or various parts thereof. Examples include, but are not limited to, fingerprints, face recognition, DNA, palm print, hand geometry, iris recognition, retinal scans, and odor/scent. In contrast, behavioral biometrics are related to the behavior of a person. Examples include, but are not limited to, typing rhythm, gait, and voice recognition. Strictly speaking, voice is also a physiological trait because every person has a different vocal tract, but voice recognition is mainly based on the study of the way a person speaks and is, therefore, commonly classified as behavioral.

Additionally or alternatively, the identification apparatus 204 can identify the user using one or more implants or other devices placed internally or externally on the body of the user. For example, the identification can rely on bio-Implants, orthopedic implants, dental implants, brain Implants, extraocular implants or any other implant. Additionally or alternatively, the identification apparatus 204 can include a password, PIN or other confirmation method.

FIG. 2 further shows that the personal device 200 can include a memory 206. In at least one implementation, the memory 206 can include any device capable of storing data in computer readable form. The memory 206 can include volatile memory and non-volatile memory. Volatile memory can include dynamic random access memory (DRAM), static random access memory (SRAM), thyristor random access memory (T-RAM), zero capacitor random access memory (Z-RAM), twin transistor random access memory (TTRAM), delay line memory, selectron tube and williams tube. Non-volatile memory can include read-only memory (ROM), programmable read only memory (PROM), erasable programmable read only memory (EPROM), electrically erasable programmable read only memory (EEPROM), flash memory, ferroelectric random access memory (FeRAM), magnetoresistive random access memory (MRAM), phase change random access memory (PRAM, aka PCM, PRAM, PCRAM, ovonic unified Memory, chalcogenide random access memory and C-RAM), conductive-bridging random access memory (CBRAM aka. programmable metallization cell or PMC), silicon-oxide-nitride-oxide-silicon (SONOS), resistive random-access memory (RRAM), racetrack memory, nano random access memory (NRAM), millipede, drum memory, magnetic core memory, plated wire memory, bubble memory and twistor memory.

In at least one implementation, the memory 206 can be used to store the required identifying information. For example, the memory 206 can be used to store the data against which the information obtained by the identification apparatus 204 is compared. I.e., the memory 206 can include the “correct” identifying information which can be compared to the acquired data to confirm the user's identify.

Additionally or alternatively, the memory 206 can include the personal data of the user. For example, the memory 206 can include health, financial or other data. I.e., the memory 206 can store the personal data that the user is seeking to protect. The data can be released once the user's identity is confirmed. For example, the personal data can be encrypted or otherwise protected and kept secure until the user's identity is confirmed.

FIG. 2 additionally shows that the personal device 200 can include a transceiver 208. In at least one implementation, the transceiver 208 can include a device comprising both a transmitter and a receiver. I.e., the transceiver 208 can transmit and receive signals which allow the personal device 200 to communicate with an external device. For example, the transceiver 208 can allow the personal device 200 to connect to a network, such as the network 102 of FIG. 1.

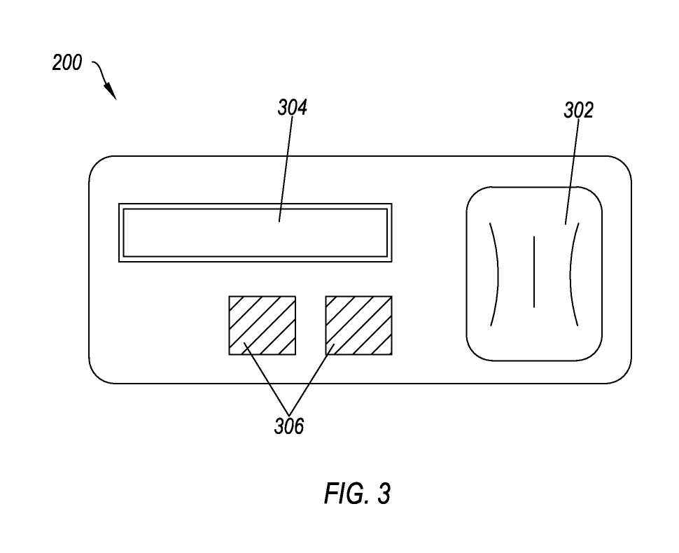

FIG. 3 illustrates an example of a personal device 200. In at least one implementation, the personal device 200 can be used to confirm personal information. For example, the personal device 200 can allow a user to share his/her medical history and/or financial data. For example, the personal device 200 may allow the user to share his/her medical history with a physician.

FIG. 3 shows that the personal device 200 can include an input 302. In at least one implementation, the input 302 can allow the user to confirm his/her identity. For example, the input 302 can include a biometric scanner. Additionally or alternatively, the input 302 can include a keyboard which allows the user to enter desired information. For example, the keyboard can allow the user to enter a PIN or password.

FIG. 3 also shows that the personal device 200 can include an electronic display 304. In at least one implementation, the electronic display 304 can include an electronic device which conveys the personal information. For example, an electronic display 304 can include any display device for presentation of information for visual, tactile or auditive reception, acquired, stored, or transmitted in electronic form. In particular, an electronic display 304 is a device that receives an electronic signal as input and converts the electronic signal to a sensory signal that can be received by a user. For example, an electronic display 304 can include television sets, computer monitors, video display panels, projectors, liquid crystal displays (“LCD”s), light emitting diode (“LED”) displays or speakers. One of skill in the art will appreciate that the electronic display 304 can include any other device that converts an electronic signal into a sensory signal unless otherwise stated in the specification or the claims.

In at least one implementation, the electronic display 304 can produce multiple types of sensory signals. In particular, the electronic display 304 can include circuitry able to produce an image, which can be viewed by a viewer, and circuitry able to produce sound, which can he heard by the viewer. For example, many televisions and computer monitors are manufactured with built in speakers. One of skill in the art will appreciate that the number of sensory signals produced by the electronic display 304 is not limiting unless otherwise stated in the specification or the claims.

For example, the electronic display 304 can include a screen. In at least one implementation, the screen serves as a surface for images to be shown on the electronic display 304. In particular, the electronic display 304 includes display circuitry which broadcasts an image, or series of images, that are shown on the screen. For example, the screen can be made of glass, plastic or other material that allows the display circuitry to broadcast the image on one side of the screen, while a user views the image from the other side of the screen. Additionally or alternatively, the screen can be a projection surface where the display circuitry can broadcast an image that is reflected to a user, who is on the same side of the screen as the electronic display 304. One of skill in the art will appreciate that the location of the display circuitry relative to the screen and to the user is not limiting unless otherwise stated in the specification or the claims.

Additionally or alternatively, the electronic display 304 can include one or more speakers. In at least one implementation, the speakers can include an electroacoustic transducer that converts an electrical signal into sound that can be perceived by a user. Specifically, the speaker can move in accordance with the variations of an electrical signal and causes sound waves to propagate through a medium. In particular, the speaker can be used to produce sound from a data signal sent to the electronic display 304. The speaker can be part of the electronic display 304 or can be an external device such as external speakers or headphones.

FIG. 3 further shows that the personal device 200 can include one or more solar cells 306. In at least one implementation, the one or more solar cells 306 can be used to charge the personal device 200. I.e., the one or more solar cells 306 can be used to power the personal device 200. In particular, the one or more solar cells 306 can allow the user to use the personal device 200 when desired, even if the user forgets to charge the personal device 200.

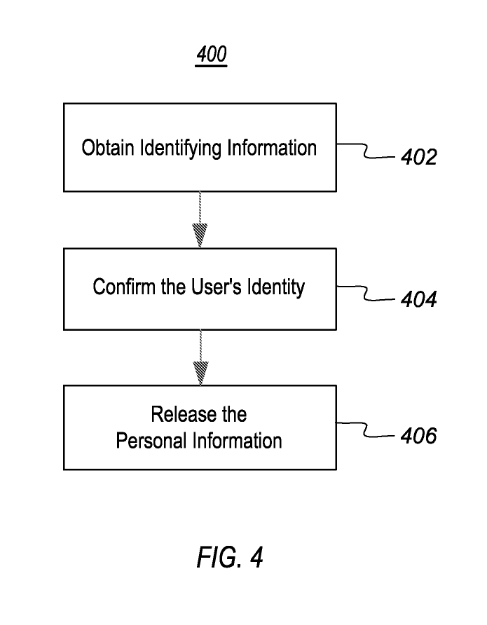

FIG. 4 is a flowchart illustrating a method 400 of sharing personal data. In at least one implementation, the method 400 can allow a user to keep his/her information confidential until the user determines it should be shared. I.e., the user can keep the information secure until he/she determines that it should be shared. In at least one implementation, the method 400 can be used with the system 100 of FIG. 1. Therefore, the method 400 will be described, exemplarily, with reference to the system 100 of FIG. 1. Nevertheless, one of skill in the art can appreciate that the method 400 can be used with a system other than the system 100 of FIG. 1.

FIG. 4 shows that the method 400 can include obtaining 402 identifying information. In at least one implementation, obtaining 402 identifying information can vary depending on what information is obtained. For example, the identifying information, such as a PIN or password, can be entered on a keyboard. Additionally or alternatively, the identifying information can be scanned other otherwise input by the user.

FIG. 4 also shows that the method 400 can include confirming 404 the user's identity. In at least one implementation, the identifying information can be compared to previously entered data. For example, the password can be compared to a saved password or saved biometric identifying data.

FIG. 4 further shows that the method 400 can include releasing 406 the user's personal data. In at least one implementation, the user's personal data can be released 406 to a second device, or a device that is different than the device used to obtain 402 the identifying data. Additionally or alternatively, the personal data can be released 406 on the device used to obtain 402 the identifying data.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for sharing a user's personal data, the method comprising:
obtaining identifying information;
confirming a user's identify; and
releasing the user's personal data.

2. The method of claim 1, wherein the identifying information includes biometric data.

3. The method of claim 2, wherein confirming the user's identity includes comparing the identifying information to previously saved data.

4. The method of claim 1, wherein the previously saved data includes at least one of:
a pin; or
a password.

5. The method of claim 1, wherein the user's personal data includes financial information.

6. The method of claim 1, wherein the user's personal data includes payment information.

7. The method of claim 1, wherein the user's personal data includes the user's medical history.

8. The method of claim 1, wherein releasing the user's personal data includes transmitting the user's personal data to an external device.

9. The method of claim 8, wherein the external device includes a payment terminal.

10. The method of claim 1, wherein the external device includes a computer.

11. A system for sharing a user's personal data, the system comprising:
a logic device;
an identification apparatus, wherein the identification apparatus is configured to confirm a user's identify; and
a transceiver, wherein the transceiver is configured to connect the system to a network.

12. The system of claim 11, wherein the logic device includes a processor.

13. The system of claim 11, wherein the transceiver is configured to transmit identifying information from the identification apparatus over the network.

14. The system of claim 13, wherein the transceiver is configured to receive confirmation of the user's identity over the network.

15. A system for sharing a user's personal data, the system comprising:
a logic device;
an identification apparatus, wherein the identification apparatus is configured to confirm a user's identify; and
a display, wherein the display is configured to display the user's personal data.

16. The system of claim 15 further comprising a power source.

17. The system of claim 16 wherein the power source includes one or more solar cells.

18. The system of claim 15 further comprising an input, wherein the input is configured to allow the user to input data.

19. The system of claim 15, wherein the input sends the input data to the identification apparatus.
